(19) United States
(12) Patent Application Publication
(10) Pub. No.: US 2015/0228194 A1
(43) Pub. Date: Aug. 13, 2015

(54) VEHICLE NAVIGATION SYSTEM, AND IMAGE CAPTURE DEVICE FOR VEHICLE

(71) Applicant: DENSO CORPORATION, Kariya-city, Aichi (JP)

(72) Inventor: Tomoo Nomura, Nagoya-city (JP)

(21) Appl. No.: 14/428,121

(22) PCT Filed: Oct. 3, 2013
(86) PCT No.: PCT/JP2013/005903

§ 371 Date: Mar. 13, 2015

(30) Foreign Application Priority Data
Oct. 3, 2012 (JP) 2012-221645
Oct. 3, 2012 (JP) 2012-221646

(51) Int. Cl. G08G 1/16; G06K 9/00; G06K 9/46; B60R 1/00

(52) U.S. Cl. CPC G08G 1/16; B60R 1/00; G06K 9/00791; G06K 9/4604; B60R 2300/10; B60R 2300/20

(57) ABSTRACT

A communication control system includes: a communication device that receives real-time information necessary for a vehicle control from an information delivery device via one of base stations; and a control device that controls the vehicle based on the real-time information. The communication device generates prediction information indicative of an index of remaining time before a communicating base station is switched with timing while the vehicle is running. The control device reduces a service level of the vehicle control for supporting at least one of a driving determination and a driving operation performed by a driver of the vehicle within the remaining time, which is shown in the prediction information.

### CROSS REFERENCE TO RELATED APPLICATION

This application is based on Japanese Patent Applications No. 2012-221645 filed on Oct. 3, 2012, and No. 2012-221646 filed On Oct. 3, 2012, the disclosures of which are incorporated herein by reference.

### TECHNICAL FIELD

The present disclosure relates to a vehicle navigation system to supply an image for navigation to a vehicle traveling along a road, and an image capture device for a vehicle to supply an image captured from an outdoor view through a vehicle's windshield.

### BACKGROUND ART

Patent literature 1 discloses the navigation system that collects motion pictures at a confusing branching point from several vehicles and supplies the motion pictures to vehicles traveling across the confusing branching point.

A motion picture reproduced by the prior art contains many moving objects such as other vehicles or pedestrians on the road. When the motion picture is reproduced, the moving objects are not found at the same positions. Just reproducing a motion picture captured by another vehicle may not effectively help a driver to understand. From this viewpoint, the vehicle navigation system needs to be further improved.

Patent literature 2 discloses the device that uses a camera to capture a view ahead of a vehicle and supports driving using the captured image.

It is favorable to capture a view outside the vehicle through the vehicle's windshield in order to protect the camera. When it rains or snows, however, a raindrop or a snowflake may stick to the outer surface of the windshield and partially hide the camera's field of view. In such a case, an acquired image does not accurately reflect the outdoor view. An image acquired under the rainy or snowy condition may not be used for the driving support.

Under another viewpoint, the windshield for vehicles such as vehicles traveling along a road and ships is provided with a wiper to wipe raindrops. The wiper may partially hide the camera's field of view. An image containing the captured wiper may not be used for the driving support.

The wiper wipes raindrops or snowflakes at a specified interval and cyclically changes the amount of raindrops or snowflakes that hides the camera's field of view. In this case, the amount of raindrops or snowflakes contained in an image cyclically varies. Such a variation generates an image usable for the driving support and an image unusable for the same.

From this viewpoint, an image capture device for vehicle needs to be further improved.

### PRIOR ART LITERATURES

### Patent Literature

Patent Literature 1: JP 2008-185394 A
Patent Literature 2: Japanese Patent No. 3984863

### SUMMARY OF INVENTION

It is an object of the present disclosure to provide a vehicle navigation system presenting an image easily understandable for a driver. It is another object of the disclosure to provide a vehicle navigation system presenting an image that suppresses an effect due to other mobile objects.

It is still another object of the disclosure to provide an image capture device for vehicle capable of suppressing the use of an image containing a large amount of noise elements captured in the image. It is still another object of the disclosure to provide an image capture device for vehicle capable of suppressing the use of an image containing a large amount of noise elements related to a wiper.

According to a first aspect of the present disclosure, a vehicle navigation system includes: an acquisition portion that acquires an original image captured at a specified point; and a generation portion that generates a clean image as an image for supporting driving at the specified point, the clean image being generated by removing at least a part of a mobile object, which includes another vehicle or a pedestrian, from the original image.

The above-mentioned vehicle navigation system generates an image to support driving at a specified point from an original image captured at the point. The vehicle navigation system supplies the image for the driving support based on an actual view at the point. In addition, the vehicle navigation system generates a clean image from the original image by removing at least part of a mobile object such as another vehicle and/or a pedestrian. Therefore, the vehicle navigation system reduces the difficulty due to mobile objects. As a result, the vehicle navigation system can suppress effects due to other mobile objects and provide an image easily understandable for a driver.

According to a second aspect of the present disclosure, an image capture device for a vehicle to provide an image, captured through a windshield of the vehicle, to an image utilization portion, includes: an acquisition portion that acquires a state of a wiper that wipes an outer surface of the windshield; and an identification portion that determines, based on the state of the wiper, whether the image is usable for the image utilization portion.

The above-mentioned image capture device for vehicle captures an image through the windshield. The image utilization portion uses the image. The wiper wipes the outer surface of the windshield. The wiper wipes a raindrop or a snowflake stuck to the outer surface of the windshield. While the wiper is operating, the wiper itself may be captured in an image. Alternatively, a raindrop or a snowflake before wiped by the wiper may be captured in an image. In such a case, the image quality degrades. As a result, an unusable image may be generated depending on the wiper state. Based on the wiper state, the identification portion determines whether or not the image is usable for the image utilization portion. As a result, this can suppress the use of a low-quality image.

### BRIEF DESCRIPTION OF DRAWINGS

The above and other objects, features and advantages of the present disclosure will become more apparent from the following detailed description made with reference to the accompanying drawings. In the drawings:

FIG. 1 is a block diagram illustrating a system according to a first embodiment of the disclosure;

FIG. 2 is a block diagram illustrating a center device according to the first embodiment;

FIG. 3 is a block diagram illustrating a vehicle device according to the first embodiment;

FIG. 4 is a flowchart illustrating a control process according to the first embodiment;

FIG. 5 is a flowchart illustrating the control process according to the first embodiment;

FIG. 6 is a flowchart illustrating the control process according to the first embodiment;

FIG. 7 is a flowchart illustrating the control process according to the first embodiment;

FIG. 8 is a plan view illustrating an example original image according to the first embodiment;

FIG. 9 is a plan view illustrating an example original image according to the first embodiment;

FIG. 10 is a plan view illustrating an example clean image according to the first embodiment;

FIG. 11 is a plan view illustrating an example guidance image according to the first embodiment;

FIG. 12 is a front view illustrating arrangement of a camera and a wiper according to a second embodiment;

FIG. 13 is a plan view illustrating an example image according to the second embodiment;

FIG. 14 is a plan view illustrating an example image according to the second embodiment;

FIG. 15 is a plan view illustrating an example image according to the second embodiment;

FIG. 16 is a plan view illustrating an example image according to the second embodiment;

FIG. 17 is a flowchart illustrating a control process according to the second embodiment;

FIG. 18 is a flowchart illustrating an effectiveness process according to the second embodiment; and

FIG. 19 is a flowchart illustrating an effectiveness process according to a third embodiment.

### EMBODIMENTS FOR CARRYING OUT INVENTION

Embodiments of the present disclosure will be described with reference to the accompanying drawings. The same reference numerals are given to parts in each embodiment similar to those described in the preceding embodiment and a redundant description may be omitted for simplicity. If only part of a configuration in each embodiment is described, other parts in the configuration may conform to those described in the preceding embodiment. A succeeding embodiment may use reference numerals whose hundreds place or higher differs from the corresponding reference numerals used for the preceding embodiment. The relationship between embodiments is indicated in this manner and a redundant description may be omitted for simplicity. Each embodiment may contain parts that are explicitly described to be capable of combination. In addition to the combination of these parts, the embodiments may be combined with each other if possible even if the embodiments are not explicitly described to be capable of combination.

### First Embodiment

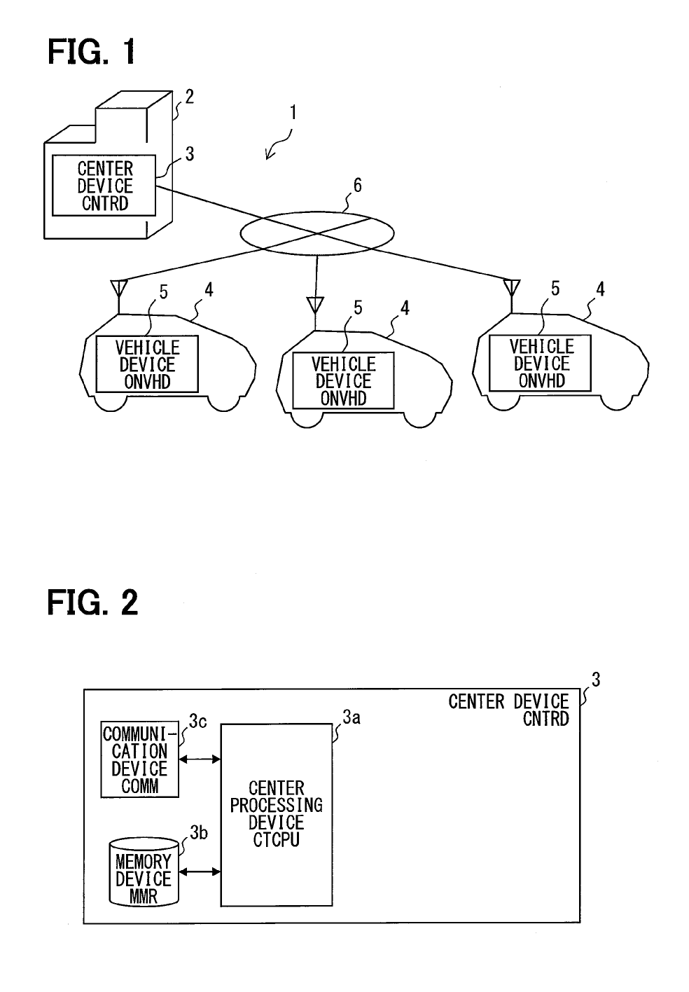

FIG. 1 illustrates a vehicle navigation system 1 according to the first embodiment of the disclosure. The vehicle navigation system 1 includes a delivery center 2 and several vehicles 3. The delivery center 2 includes a center device (CNTRD) 3. The vehicle 4 includes a vehicle device (ONVHD) 5. A communication system 6 is provided between the center device 3 and the vehicle device 5 for data communication. The center device 3 connects with the several vehicle devices 5 to be capable of data communication via the communication system 6. The communication system 6 may include networks such as a wireless telephone line and the Internet. The center device 3 and the vehicle device 5 configure the vehicle navigation system 1.

The center device 3 delivers a guidance image to the vehicle devices 5. The delivered image represents as still picture or a motion picture. The vehicle devices 5 received the delivered image. A navigation system mounted on the vehicle 4 may provide each vehicle device 5. The navigation system displays the delivered image and thereby supplies a driver with the image and supports the driver's driving. When the vehicles 4 capture images, the vehicle devices 5 mounted on the vehicles 4 transmit the captured images to the center device 3. The center device 3 collects the images transmitted from the vehicle devices 5 and processes the images to generate an image for delivery. The vehicle navigation system 1 processes the images collected from the vehicle devices 5 and delivers the processed images.

As illustrated in FIG. 2, the center device 3 includes a center processing device (CTCPU) 3a and a memory device (MMR) 3b. The memory device 3b stores data. The center processing device 3a and the memory device 3b configure a microcomputer. The center device 3 includes a communication device (COMM) 3c that provides connection with the communication system 6.

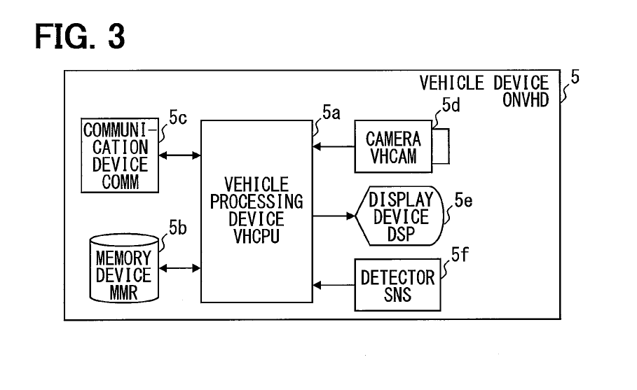

As illustrated in FIG. 3, the vehicle device 5 includes a vehicle processing device (VHCPU) 5a and a memory device (MMR) 5b. The memory device 5b stores data. The vehicle processing device 5a and the memory device 5b configure a microcomputer. The vehicle device 5 includes a communication device (COMM) 5c that provides connection with the communication system 6. The vehicle device 5 includes a camera (VHCAM) 5d that captures images around the vehicle 4. The camera 5d captures images ahead of the vehicle. The camera 5d is capable of capturing a still picture or a motion picture. The camera 5d captures a view ahead of the vehicle 4 and thereby supplies an original image. The vehicle device 5 provides an image capture device for vehicle. The vehicle device 5 includes a display device (DSP) 5e.

The vehicle device 5 includes several detectors 5f. The detectors 5f include sensors needed for the navigation system. For example, the detectors 5f may include a satellite positioning device to detect the current position of the vehicle 4. The detectors 5f may include a sensor to detect the behavior of the vehicle 4. For example, the detectors 5f may include a speed sensor to detect a travel speed of the vehicle 4 and a brake sensor to detect manipulation of a braking device. The detectors 5f include a sensor to detect the driver's behavior. For example, the detectors 5f may include an indoor camera to capture the driver's face, a microphone to detect the driver's voice, and a heartbeat sensor to detect the driver's heartbeat.

The vehicle device 5 provides a navigation system mounted on the vehicle 4. The vehicle device 5 displays a map on the display device 5e and displays the position of the vehicle 4 on the map. Further, the vehicle device 5 provides route guidance from the current position to a destination in response to a request from a user of the vehicle 4. The vehicle device 5 includes a means to settle a route from the current position to a destination. The vehicle device 5 displays the settled route on the map displayed on the display device 5e and provides visual or audible assistance so that the driver can drive the vehicle along the route.

The center device 3 and the vehicle device 5 represent an electronic control unit (ECU). The ECU includes a processor and a memory device as a storage medium to store a program. The ECU is provided as a microcomputer including a computer-readable storage medium. The storage medium permanently stores a computer-readable program. The storage medium is available as semiconductor memory or a magnetic disk. The program is executed by the ECU and enables the ECU to function so that the ECU is available as a device described in this specification and performs a control method described in this specification. A means provided by the ECU may be referred to as a function block or module that achieves a specified function.

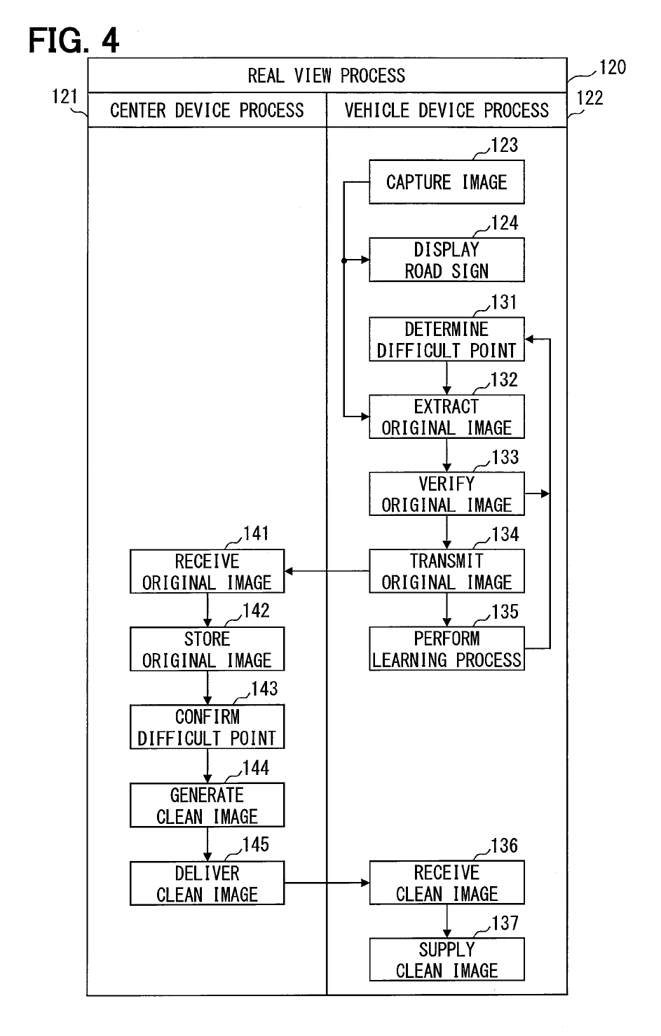

FIG. 4 is a flowchart illustrating a real view process 120 related to the real view navigation provided by the vehicle navigation system 1. The real view navigation provides a succeeding vehicle with an image captured by a preceding vehicle. In addition, a clean image is delivered to the succeeding vehicle. The clean image is generated by removing moving objects such as other vehicles and, more favorably, pedestrians from an image captured by the preceding vehicle. Original images are collected from preceding vehicles to generate the clean image. The real view navigation extracts a range of view containing information useful for supporting the driving from the view ahead of the vehicle and allows the display device 5e to display the extracted view. The real view process 120 contains a center device process 121 performed by the center device 3 and a vehicle device process 122 performed by the vehicle device 5. Each step of the process may be considered as a processing means or portion to provide the corresponding function.

At step 123, the vehicle device 5 captures an image ahead of the vehicle 4. The process at step 123 may contain a selection process that selects only an available image from images captured by the camera 5d. For example, the selection process discards an image containing a wiper to remove raindrops adhering to the vehicle's windshield.

At step 124, the vehicle device 5 performs a process that allows the display device 5e to display a road sign appearing ahead of the vehicle 4. The process identifies the road sign from an image captured by the camera 5d. For example, the process identifies a road sign that indicates the destination of an intersection ahead. This process also extracts a partial image corresponding to the road sign from the original image and allows the display device 5e to display an enlarged version of the extracted image. This enables to help the driver recognize the road sign.

At step 131, the vehicle device 5 determines whether or not the vehicle 4 travels a difficult point. The difficult point corresponds to a point on a road that makes it difficult for the driver to understand the road structure or the course. The difficult point may include a difficult intersection, namely, a branching point. The difficult point may include a branching point with many branches or a branching point with a special branch angle. Such an intersection is also referred to as a difficult intersection. The difficult point may include an entrance to the destination of the vehicle 4, a parking area entrance, or a similar point making it difficult to find while the vehicle travels. The difficult point may be determined automatically. Further, there may be provided a switch the driver manipulates when he or she finds a difficult point. The difficult point may be determined in response to manipulation of the switch.

The vehicle device 5 may determine that the vehicle 4 encounters a difficult point when detecting an abnormal event different from the normal state. For example, the vehicle device 5 may detect that the driver finds it difficult to select the travel direction at an intersection. In such a case, the vehicle device 5 can determine whether or not the intersection is a difficult intersection. The vehicle device 5 can use the behavior of the vehicle 4 or the driver to determine that the driver finds it difficult to select the travel direction. The behavior of the vehicle 4 may include the driver's manipulation on the vehicle 4, the state of the vehicle 4, and acceleration and deceleration of the vehicle 4.

The vehicle device 5 may determine a difficult point based on the driver's manipulation on the vehicle 4 or the behavior of the vehicle 4. An example of the vehicle behavior indicating a difficult point is sudden deceleration or sudden braking within a candidate range indicating candidate points such as intersections. Another example is slow driving in a candidate range. Still another example is stopped driving in a candidate range. Yet another example is meander driving in a candidate range. A difficult point may be determined based on a combination of several vehicle behaviors such as deceleration and meander driving.

To determine a difficult point, the vehicle device 5 compares the observed vehicle behavior with a predetermined reference behavior. If the observed vehicle behavior deviates from the reference behavior, the vehicle device 5 can determine the corresponding point as a difficult point. The reference behavior can be predetermined based on behaviors of many vehicles at the difficult point. The reference behavior may be also referred to as a standard behavior. The reference behavior can be adjusted to conform to a specific driver's personality. The reference behavior can be adjusted manually or according to a learning process to be described later.

The difficult point can be determined based on the driver's behavior. For example, the vehicle device 5 can determine whether or not the driver travels a difficult point based on the behavior such as the driver's body action, voice, or heartbeat. Specifically, the vehicle device 5 can use facial expressions, eye movement, or head movement. The vehicle device 5 can use the voice uttered by the driver when he or she takes a wrong route. More specifically, the vehicle device 5 can use uttered words such as “oops,” “damn,” “no,” and “what.” The vehicle device 5 can also use a sudden change in the heart rate.

To determine a difficult point, the vehicle device 5 compares the observed driver behavior with a predetermined reference behavior. If the observed driver behavior deviates from the reference behavior, the vehicle device 5 can determine the corresponding point as a difficult point. The reference behavior can be predetermined based on behaviors of many drivers at the difficult point. The reference behavior may be also referred to as a standard behavior. The reference behavior can be adjusted to conform to a specific driver's personality. The reference behavior can be adjusted manually or according to a learning process to be described later.

A difficult point may be determined based on a fact that the vehicle 4 deviates from a predetermined route scheduled for the route guidance. The vehicle 4 may deviate from the route at an intersection while the vehicle device 5 performs the route guidance. In such a case, the intersection is likely to be a difficult intersection.

Step 131 provides a determination portion that determines a difficult point on a road that makes it difficult for the driver to understand the road structure or the course. The determination portion determines the difficult point based on comparison between the vehicle behavior and/or the driver behavior and the reference. Images for driving support can be automatically provided because the difficult point is determined automatically.

At step 132, the vehicle device 5 extracts an image capturing the difficult point as an original image. This image is a raw image captured by the camera 5d from the vehicle 4. The original image contains at least one still image captured by the camera 5d immediately before the difficult point is reached. The difficult point is highly likely to be captured in such an image so that the corresponding road structure can be viewed. The original image may include several still pictures or motion pictures captured in a specified zone before the difficult point is reached or in a specified zone containing the difficult point. The original image can be selectively extracted from still pictures or motion pictures captured in a specified travel distance or a specified travel period containing the difficult point.

At step 133, the vehicle device 5 verifies the difficult point at step 131 based on the original image. This verification also determines whether or not the point captured in the original image is a difficult point. The determination of the difficult point at step 131 may contain an error. If the possibility of a difficult point falls short of a specified value at step 133, the vehicle device 5 discards the original image and returns to step 131 by skipping the succeeding process. This can improve the accuracy of difficult point determination.

Events like vehicle behavior, driver behavior, and route deviation may be observed at difficult points. Such events indicate a difficult point and may occur due to other causes. An original image captured at the point is likely to contain the causes other than the difficult point. A thing indicating the cause other than the difficult point may be referred to as an error thing. The determination portion can verify the determination by determining whether or not the original image contains an error thing captured.

To perform this process, the vehicle navigation system 1 previously registers and stores an error thing that may be contained in the original image due to a cause other than the difficult point. Further, the vehicle device 5 processes the original image to determine whether or not an error thing is captured. If an error thing is captured in the original image, the determination at step 131 may be assumed to be an error. An error process can be performed. If the determination at step 131 results in an error, the vehicle device 5 can discard the original image acquired at step 132. If the determination at step 131 may not be assumed to be an error, the vehicle device 5 performs the succeeding process including a provision process that provides an image to support driving at a difficult point based on the original image. Namely, the vehicle device 5 performs the succeeding provision process if a verification portion verifies that the determination portion correctly determines the difficult point. The verification portion discards the original image if correctness of the difficult point is not verified. The vehicle device 5 does not perform the succeeding provision process if the verification portion does not verify that the determination of the difficult point is correct.

A difficult point may be determined based on the vehicle behavior or the driver behavior. In such a case, the determination may be incorrect. This is because the vehicle behavior or the driver behavior observed at a difficult point may occur based on other causes. For example, sudden braking at an intersection may result from several causes such as a difficult intersection, sudden braking of a preceding vehicle, and an approaching pedestrian. One example of the error thing is a brake lamp that lights in red more extensively than a specified area to notify sudden braking of a preceding vehicle at close range. Another example of the error thing is a pedestrian at close range.

At step 134, the vehicle device 5 transmits the original image to the center device 3. At step 134, there is provided a transmission portion that transmits the original image from the vehicle device 5 to the center device 3. One or more original images are transmitted. At step 134, the vehicle device 5 can transmit an image of one or more difficult points.

The camera 5d may be mounted in the vehicles 4 at different positions. Models of the camera 5d may differ depending on the vehicles 4. The image transmitted at step 134 is supplied with information about capture conditions such as the model and the position of the camera 5d and a capture range. The capture conditions may contain information such as a traveled lane and a date when the capture was performed. These types of information are used to identify a difference between original images depending on the vehicles 4 and correct the images.

When the original image is captured, the vehicles 4 may be differently positioned. The image transmitted at step 134 contains the information indicating the capture position. For example, the information contains a distance between the position to capture the original image and a reference point such as the intersection center. The information is used to identify a difference between original images depending on the vehicles 4 and correct the images.

The process at step 134 notifies the center device 3 of the presence and the position of a difficult point. This process enables the center device 3 to identify the presence of a difficult point. In response to the notification of the presence of the difficult point, the center device 3 can also perform a process that provides the other succeeding vehicles 4 with support information to support drivers at the difficult point.

At step 135, a learning process is performed to correct the reference used to determine a difficult point at step 131. The process at step 135 provides a learning portion to correct the reference based on the vehicle behavior and/or the driver behavior observed at the difficult point. At step 135, the vehicle device 5 detects a case where the possibility of a difficult point exceeds a specified criterion. In this case, the vehicle device 5 corrects the reference indicating the difficult point based on the observed vehicle or driver behavior. The reference indicating the difficult point is provided as a threshold value or the behavior itself corresponding to the difficult point. If a branch of the intersection is indeterminable, the vehicle behavior and the driver behavior are observed and depend on each driver. This process can improve the accuracy of difficult point determination.

An example of the reference correction compares the behavior observed by a sensor with the specified reference value and indicates a difficult point as a result. For example, a difficult point is identified when the detected behavior exceeds the specified reference value. In such a case, the reference value is corrected based on the behavior observed when there is a high possibility of a difficult point.

Another example of the reference correction corrects the reference value for the amount of brake manipulation to determine a difficult point based on the amount of brake manipulation observed at the difficult point. If the observed amount of brake manipulation is smaller than the current reference value, the reference value may be corrected to be smaller than the current value. If the observed amount of brake manipulation is larger than the current reference value, the reference value may be corrected to be larger than the current value.

Still another example of the reference correction corrects the reference value for a steering wheel angle to determine a difficult point based on the steering wheel angle observed at the difficult point. If the observed steering wheel angle is smaller than the current reference value, the reference value may be corrected to be smaller than the current value. If the observed steering wheel angle is larger than the current reference value, the reference value may be corrected to be larger than the current value.

Yet another example of the reference correction corrects the reference value for the amount of changes in the heart rate to determine a difficult point based on the amount of changes in the driver's heart rate observed at the difficult point. If the observed amount of changes in the heart rate is smaller than the current reference value, the reference value may be corrected to be smaller than the current value. If the observed amount of changes in the heart rate is larger than the current reference value, the reference value may be corrected to be larger than the current value.

Still yet another example of the reference correction uses the behavior observed when there is a high possibility of a difficult point, and assumes the observed driver behavior to be “the reference to indicate the difficult point” specific to the driver. For example, the reference is corrected so that the driver's voice observed at a difficult point is used as the reference voice to determine the difficult point. One driver may utter “damn!” at the difficult point. Another driver may utter “oh!” at the difficult point. The uttered word “damn!” is assumed to be the reference in the former case and the uttered word “oh!” is assumed to be the reference in the latter case so that the reference is settled to conform to the driver's personality.

At step 141, the center device 3 receives the original images transmitted from the vehicle devices 5. At step 142, the center device 3 stores the received original images in the memory device 3b. The memory device 3b stores the original images corresponding to the points. The memory device 3b can store different original images per point.

The process at steps 141 and 142 provides an acquisition portion that acquires an original image captured at a specified point, namely, a difficult point. The acquisition portion acquires information indicating a capture condition for each original image. The acquisition portion includes a center reception portion that is provided at step 141 and receives an original image transmitted from the transmission portion. The acquisition portion includes a storage portion that is provided at step 142 and stores several original images.

At step 143, the center device 3 performs a process that confirms whether or not a point indicated in the original image is valid as a difficult point to which the clean image needs to be supplied. To perform the confirmation process, an operator views the original image and makes a determination. The confirmation process can contain a determination whether or not more original images than a specified threshold value are stored per point. An affirmative result from the determination signifies that the point is assumed to be a difficult point for a lot of vehicles 4. In this case, it is favorable to assume the point to be a difficult point and provide the clean image to be described later. Step 144 is performed if the validity as a difficult point is affirmed at step 143. Step 144 concerning the point is omitted if the validity as a difficult point is negated at step 143.

Step 143 provides a confirmation portion that confirms a point where the original image was captured is valid as a point to generate a clean image. When confirming that the point is valid, the confirmation portion permits a generation portion to generate a clean image. The confirmation portion confirms that the point is valid to generate a clean image when the number of stored original images exceeds a specified threshold value.

At step 144, the center device 3 generates a clean image based on the original image. At step 144, the center device 3 generates a clean image at the difficult point. The clean image is void of mobile objects such as other vehicles and pedestrians captured. The clean image may be generated by selecting an original image with no mobile object captured from the stored original images per point. Alternatively, the clean image may be generated by removing mobile objects such as other vehicles and pedestrians captured from the original image.

To generate a clean image, an operator processes and corrects the original image. This manual process generates the clean image based on stored original images related to a targeted point. To generate a clean image, an image processing program can automatically generate one or more clean image based on the original images.

A process to generate a clean image includes several processes such as selecting a base image, identifying a mobile object in the base image, selecting another original image capable of supplying a background image to remove the mobile object, and synthesizing the other original image with the base image. The memory device 3b temporarily stores the images regardless of the manual process or the automatic process using the image processing program.

Selecting the base image is comparable to selecting one of original images that clearly indicates the difficult point. For example, the base image can be selected if it is an original image whose capture position is located within a specified range from the reference point of a difficult point such as a difficult intersection. Alternatively, the base image can be selected if it is an original image that satisfies a specified condition settled based on the width of a road connected to the difficult intersection. A mobile object in the base image can be identified based on a predetermined reference shape indicating a vehicle or a pedestrian.

Selecting another original image is comparable to selecting an original image similar to the base image. For example, another original image can be selected if it is an original image whose capture position is located within a specified range from the capture position of the base image. Alternatively, another original image can be selected if it is an original image that captures the position or shape of a remarkable object in the image such as a road sign similarly to the base image. Specifically, a stop line or a crosswalk may be used. It may be favorable to use an image process to recognize a range in the intersection.

A correction process based on a capture position or a date is performed to synthesize the base image with the other images (parts). The correction based on the capture position may include horizontal correction based on driving lane differences when the original image was captured. The correction based on the capture position may also include vertical correction based on height differences of the camera 5d. At least one mobile object is removed from the base image to generate a clean image. To do this, the other part of the original image is synthesized with the base image.

Step 144 provides the generation portion that removes at least part of the mobile object such as the other vehicles and/or pedestrians from one original image to generate a clean image. The clean image is generated to support driving at a difficult point. The generation portion generates the clean image based on several original images. The generation portion synthesizes the original images based on capture conditions attached to the original images. To generate the clean image void of a mobile object, the generation portion synthesizes a range of one original image containing the captured mobile object with partial images in the other original images. Therefore, it is possible to provide an image approximate to the real scenery even if mobile objects are removed.

At step 145, the center device 3 delivers the clean image to the vehicle device 5. Step 145 included in the center device 3 provides a delivery portion that delivers a clean image to the vehicle device 5. The center device 3 can deliver the clean image to several vehicles 4. The center device 3 can deliver the clean image in response to a request from the vehicle 4. The center device 3 may deliver the clean image to the vehicle 4 that is going to reach one difficult point.

At step 136, the vehicle device 5 receives the clean image. Step 136 provides a vehicle reception portion that receives a clean image delivered from the delivery portion and stores the clean image in the memory device 5b.

At step 137, the vehicle device 5 supplies the clean image to the driver. The display device 5e displays the clean image. The vehicle device 5 uses the clean image for route guidance. For example, the vehicle device 5 displays the clean image on the display device 5e before the vehicle 4 reaches a difficult point.

If the route guidance is performed, a guidance symbol can be displayed so as to overlap with the clean image. The guidance symbol may be provided as an arrow indicating a route or a multi-headed arrow indicating several branch directions selectable at a fork road. An image containing the clean image and the guidance symbol may be referred to as a guidance image. The vehicle device 5 can synthesize the guidance symbol with the clean image. The center device 3 may synthesize the guidance symbol with the clean image. The clean image and the guidance image are used for driving support.

Steps 132 through 134, 141 through 145, and 136 and 137 provide a provision portion that provides an image to support driving at a difficult point based on the original image captured at the difficult point. According to the embodiment, at least steps 144, 145, 136, and 137 provide the provision portion. Step 137 provides a display portion that allows the display device 5e to display a clean image stored in the memory device 5b when the vehicle travels a difficult point.

Steps 131 through 137 and 141 through 145 provide an image delivery process that provides an image to support driving at a difficult point based on the original image captured at the difficult point. According to the embodiment, a sign display process provided at step 124 or the image delivery process provided at steps 131 through 145 provides a utilization portion that uses an image captured at step 123.

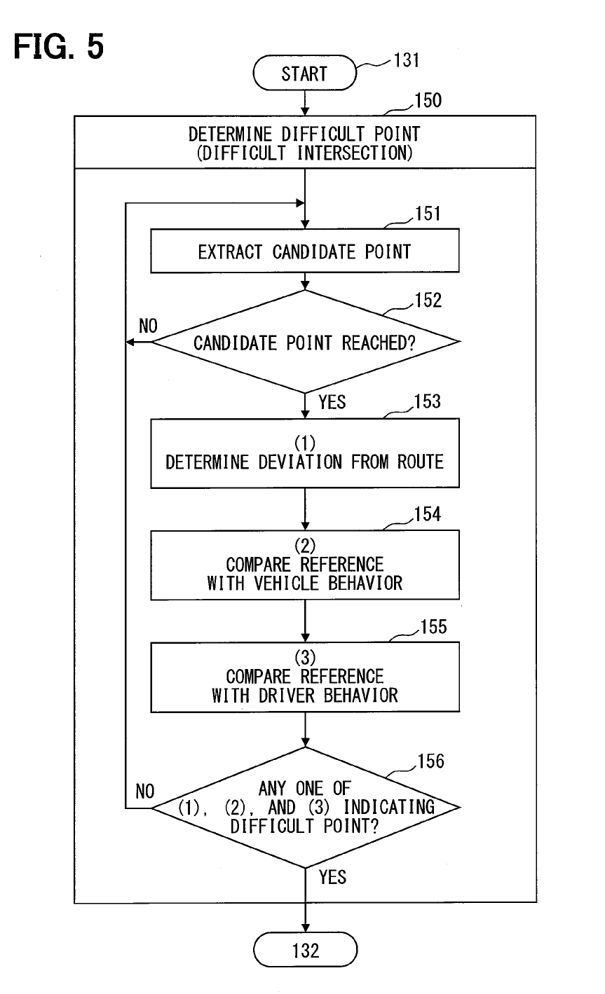

FIG. 5 illustrates a process 150 that determines a difficult point such as a difficult intersection. The process 150 provides an example of step 131. The vehicle device 5 performs the process 150.

At step 151, the vehicle device 5 extracts a candidate point. The candidate point is likely to be a difficult point. To determine a difficult intersection, the vehicle device 5 extracts the difficult intersection allowing a driver to possibly choose an incorrect travel direction from several intersections registered to the memory device 5b.

At step 152, the vehicle device 5 determines whether or not the vehicle 4 reaches the candidate point. If the determination is negated, the vehicle device 5 returns to step 151. If the determination is affirmed, the vehicle device 5 proceeds to step 153.

At step 153, the vehicle device 5 determines whether or not the vehicle 4 deviates from a predetermined route for route guidance at the candidate point. The intersection is highly likely to be a difficult point if the vehicle 4 deviates from the predetermined route at the intersection. If the vehicle 4 deviates from the predetermined route, the vehicle device 5 determines at step 153 that the candidate point is a difficult point.

At step 154, the vehicle device 5 compares the reference with the vehicle behavior observed at the candidate point. At step 154, the vehicle device 5 determines whether or not the observed vehicle behavior deviates from the reference. If the observed vehicle behavior deviates from the reference, the vehicle device 5 determines that the candidate point is a difficult point.

At step 155, the vehicle device 5 compares the reference with the driver behavior observed at the candidate point. At step 154, the vehicle device 5 determines whether or not the observed driver behavior deviates from the reference. If the observed driver behavior deviates from the reference, the vehicle device 5 determines that the candidate point is a difficult point.

At step 156, the vehicle device 5 determines whether or not any one of determination processes (1), (2), and (3) at steps 153 through 155 indicates that the candidate point is a difficult point. The vehicle device 5 proceeds to step 132 if any one of determination processes (1), (2), and (3) indicates that the candidate point is a difficult point. The vehicle device 5 returns to step 151 if the determination at step 156 is negated.

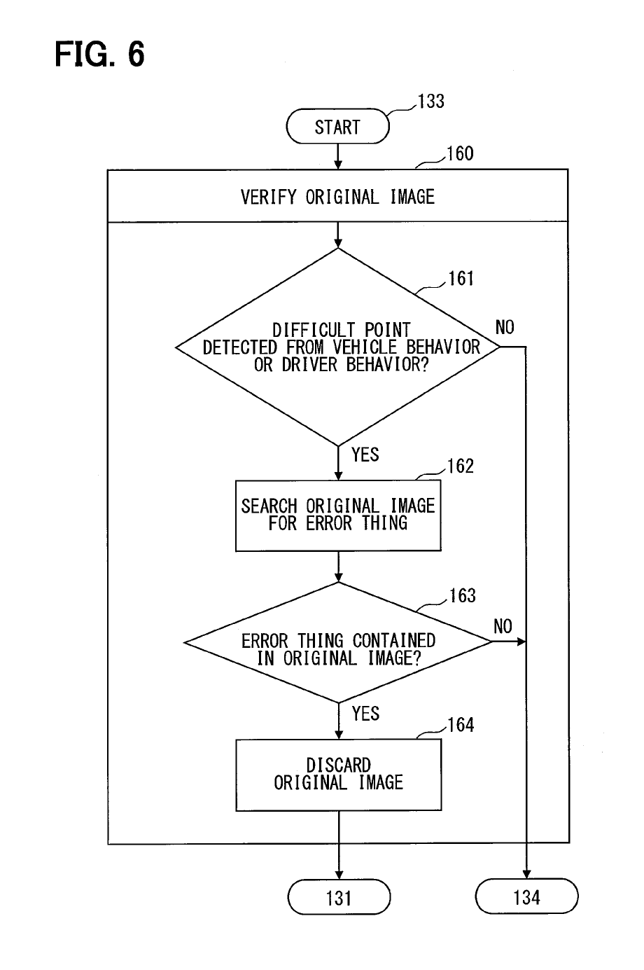

FIG. 6 illustrates a process 160 that verifies the determination of the difficult point based on the original image. The process 160 provides an example of step 133. The vehicle device 5 performs the process 150.

At step 161, the vehicle device 5 determines whether the difficult point is detected from the vehicle behavior or the driver behavior. Therefore, the determination at step 161 is affirmed if the determination at step 154 or 155 is affirmed. The vehicle device 5 proceeds to step 134 if the determination at step 161 is negated. The vehicle device 5 proceeds to step 162 if the determination at step 161 is affirmed.

At step 162, the vehicle device 5 performs an image recognition process that searches the original image for an error thing. At step 163, the vehicle device 5 determines whether or not the original image contains an error thing. The vehicle device 5 proceeds to step 134 if the determination at step 163 is negated. The vehicle device 5 proceeds to step 164 if the determination at step 163 is affirmed. At step 164, the vehicle device 5 discards the original image acquired at step 132. The vehicle device 5 then returns to step 131.

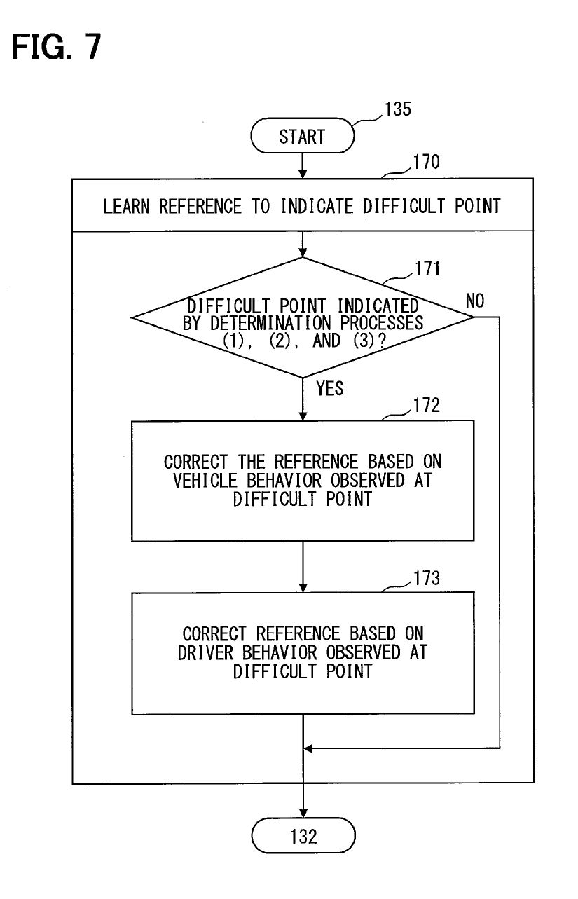

FIG. 7 illustrates a process 170 that learns the reference to indicate a difficult point. The process 170 provides an example of step 135. The vehicle device 5 performs the process 170.

At step 171, the vehicle device 5 determines whether or not determination processes (1), (2), and (3) at steps 153 through 155 indicate that the candidate point is a difficult point. The vehicle device 5 proceeds to step 172 if at least two of determination processes (1), (2), and (3) indicate that the candidate point is a difficult point. The vehicle device 5 returns to step 132 if the determination at step 171 is negated.

According to the embodiment, the determination portion provided at step 131 contains several determination processes at steps 153 through 155. Step 171 provides a determination portion that determines whether or not the reliability of the determination about the difficult point is higher than or equal to a specified level. As a result, the learning portion performs correction if at least two determination processes determine a difficult point.

At step 172, the vehicle device 5 corrects the reference for the vehicle behavior based on the vehicle behavior observed at the difficult point. At step 173, the vehicle device 5 corrects the reference for the driver behavior based on the driver behavior observed at the difficult point. The reference at step 173 may use the driver's behavior such as his or her voice observed at the difficult point, for example.

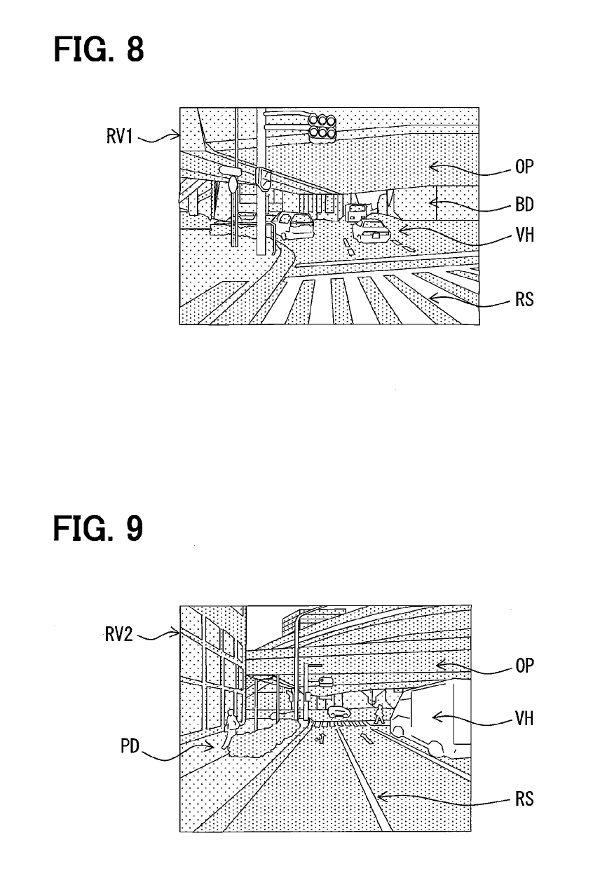

FIGS. 8 and 9 illustrate example original images. The images are captured by the camera 5d and are simplified for an illustration purpose. Original image RV1 and original image RV2 are captured from the same intersection. Original image RV1 is acquired in response to the determination about the difficult intersection in one vehicle 4. Original image RV2 is acquired in response to the determination about the difficult intersection in another vehicle 4. Original image RV1 and original image RV2 are captured on different dates at different positions.

Original images RV1 and RV2 capture the scenery at the intersection. As illustrated in the drawings, original images RV1 and RV2 contain road sign RS as well as building BD and overpass OP which are both parts of the scenery. The intersection has a large area. Therefore, building BD in the distance looks smaller. Installations including a traffic light obstruct the field of view. Overpass OP covers a wide range, causing the entire image dark. These factors make it difficult to recognize each fork road.

Original images RV1 and RV2 contain another vehicle VH and pedestrian PD as mobile objects. Therefore, original images RV1 and RV2 differently represent the scenery. Just viewing original images RV1 and RV2 makes it difficult to accurately recognize the intersection shape and select a fork road to travel.

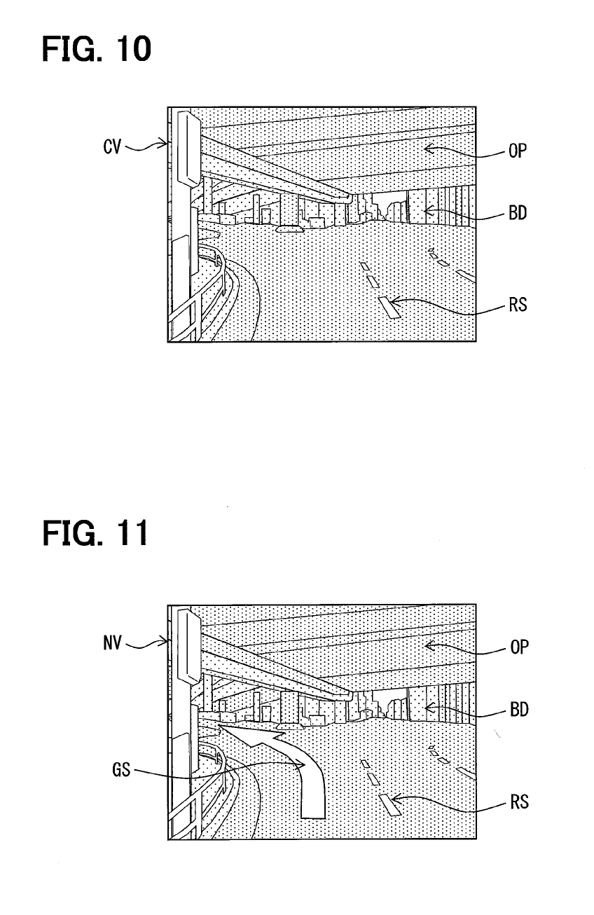

FIG. 10 illustrates an example clean image synthesized by the center device 3. The image is captured by the camera 5d and is simplified for an illustration purpose. Clean image CV is synthesized at step 144. Clean image CV contains road sign RS as well as building BD and overpass OP which are both parts of the scenery. Clean image CV does not contain at least any remarkable mobile object. Clean image CV may contain a small mobile object that can be identified with background building BD. Clean image CV is synthesized based on original images RV1 and RV2. Clean image CV ensures as high resolution as original images RV1 and RV2. Clean image CV provides the photorealistic quality rather than schematic illustrations representing buildings.

FIG. 11 illustrates an example guidance image displayed by the vehicle device 5 on the display device 5e. Guidance image NV displayed on the display device 5e ensures as high resolution as clean image CV. Guidance image NV can provide the same image quality as clean image CV. Guidance image NV is synthesized with guidance symbol GS for route guidance performed by a route guidance function of the vehicle device 5. In the illustrated example, guidance symbol GS indicates the travel direction to one of fork roads to enter. The center device 3 or the vehicle device 5 can synthesize guidance symbol GS with the clean image.

The embodiment generates an image to support driving at the difficult point from the original image captured at the difficult point. An image for driving support is provided based on the actual scenery at the difficult point.

As an example, a preceding vehicle passing through the difficult point supplies an original image. The clean image is synthesized based on the original image and is supplied as a guidance image for a succeeding vehicle. The clean image is generated based on the scenery at the difficult point viewed from the preceding vehicle. As a result, the driver of the succeeding vehicle can be supplied with the guidance image approximate to the actual scenery viewed at the difficult point.

The clean image is generated by removing at least part of mobile objects such as other vehicles and/or pedestrians from the original image. The clean image reduces the difficulty due to mobile objects. As a result, this enables to suppress effects due to other mobile objects and provide an image easily understandable for the driver.

### Other Embodiments

While there has been described the preferred embodiment of the disclosures, the disclosures are not limited to the above-mentioned embodiment but may be variously modified. The structures of the above-mentioned embodiment are only examples. The technological scope of the disclosures is not limited to the scope of the described embodiment. The disclosures are not limited to the combinations shown in the embodiment but may be embodied independently.

For example, the means and the functions provided by the control unit are available as software only, hardware only, or a combination of these. For example, the control unit may be configured as an analog circuit.

According to the description of the above-mentioned embodiment, the several vehicles 4 passing through a difficult point acquire several original images. A clean image is generated based on the original images and is supplied to another succeeding vehicle 4 that is supposed to reach the difficult point. However, the vehicle navigation system may generate a clean image based on original images repeatedly acquired by one vehicle 4 and supply the clean image to the same vehicle 4.

According to the above-mentioned embodiment, the center device 3 and the vehicle device 5 share steps 131 through 145. Instead, the center device 3 and the vehicle device 5 may share the steps differently from the above-mentioned embodiment. For example, the center device 3 may perform all or part of steps 131 through 135. The vehicle device 5 may perform all or part of steps 141 through 145.

The above-mentioned embodiment performs steps 131 through 135 in real time while the vehicle 4 travels. Instead, steps 131 through 135 may be performed after the vehicle 4 travels during a specified period. In this case, there is added a process that allows the memory device 5b to store information observed during the travel of the vehicle 4. Steps 131 through 135 are performed based on the stored information.

To generate a clean image, the above-mentioned embodiment removes both another vehicle and a pedestrian from an original image. Instead, one of another vehicle and a pedestrian may be removed from the original image to generate a clean image.

According to the above-mentioned embodiment, only the vehicle device 5 perform step 124. Instead, the center device 2 may perform part of step 124. For example, the center device 3 may collect sign images in the memory device 3b, select the most recent and high-quality sign image from the collected images, and deliver the selected sign image to the vehicle device 5 that displays the delivered sign image.

### Second Embodiment

The vehicle navigation system 1 according to the second embodiment will be described. The image capture device for vehicle supplies an image captured through a windshield of the vehicle 4 to an image utilization portion to be described later.

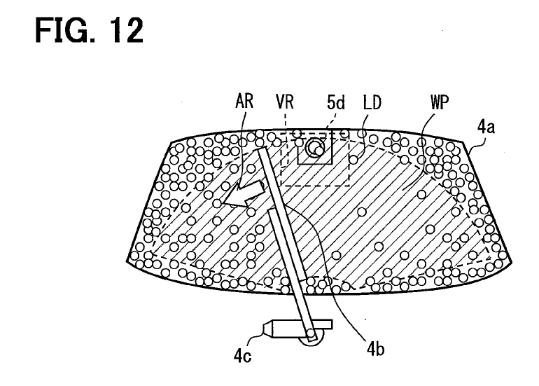

FIG. 12 is a plan view illustrating a front windshield 4a viewed from the front of the vehicle 4. FIG. 12 illustrates the windshield 4a, a wiper 4b, a wiper motor 4c, and a camera 5d. An arrow depicts moving direction AR of the wiper 4b in the illustrated state. A hatched range enclosed in a broken line depicts wipe range WP of the wiper 4b. Circles in the drawing signify simplified representation of many raindrops LD. The circles illustrate an example state of many stuck raindrops LD while the wiper 4b is operating. A snowflake may stick similarly to raindrop LD.

The windshield 4a is a transparent plate made of glass, for example. The wiper motor 4c drives the wiper 4b. The wiper 4b wipes the outer surface of the windshield 4a.

The camera 5d is installed in a vehicle compartment of the vehicle 4. The camera 5d is placed at the rear of the windshield 4a. The camera 5d captures a view outside the vehicle 4 through the windshield 4a. The camera 5d captures a forward view in the travel direction of the vehicle 4. Capture range VR of the camera 5d and wipe range WP at least partially overlap with each other. According to the illustrated example, almost the entire capture range VR of the camera 5d overlaps wipe range WP.

Raindrop LD sticks to the outer surface of the windshield 4a. The wiper 4b wipes wipe range WP at a specified cycle. The number of raindrops LD stuck to the inside of wipe range WP is smaller than the number of raindrops LD stuck to the outside thereof. The wiper 4b reciprocates within wipe range WP. The wiper 4b repeats a wipe stroke indicated by moving direction AR. The number of raindrops LD stuck forward in moving direction AR of the wiper 4b is larger than the number of raindrops LD stuck backward in moving direction AR thereof. The rear of the wiper 4b in the moving direction leaves the small number of raindrops LD in a range immediately after the wiper 4b passes. Increasing the distance from the rear of the wiper 4b increases the number of stuck raindrops LD. In other words, there remains the smallest number of raindrops LD immediately after the wiper 4b passes. After the wiper 4b passes, the number of raindrops LD gradually increases with the lapse of time.

Raindrop LD also sticks to the field of view for the camera 5d. Raindrop LD is also contained in an image captured by the camera 5d. In addition, raindrop LD comes close to the camera 5d and is much distanced from the focus of the camera 5d toward the camera 5d. Therefore, the image sharpness is degraded within the range of raindrops LD. No frontal view is recognizable within the range of raindrops LD.

The wiper 4b may pass through capture range VR of the camera 5d. Part of the wiper 4b may be captured in an image. The wiper 4b is captured as a big shadow in the image.

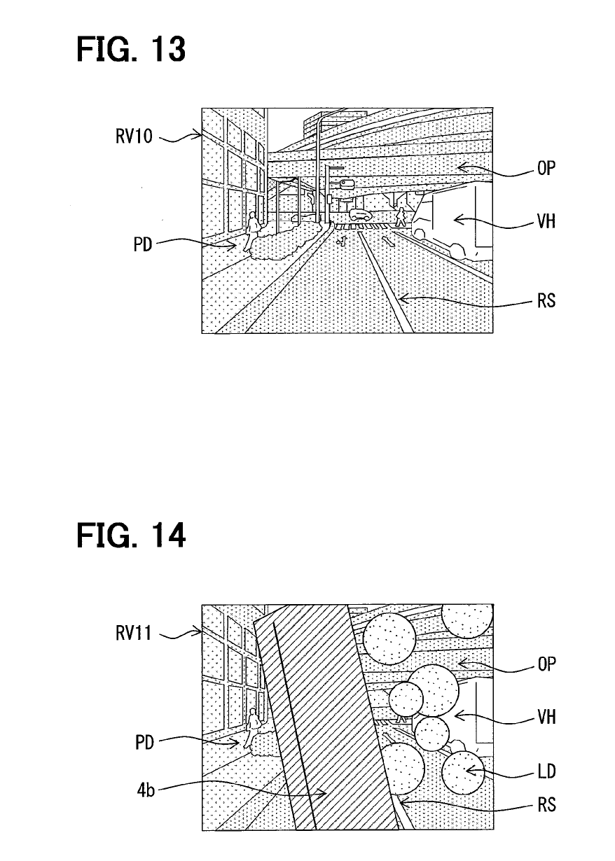

FIGS. 13 through 16 illustrate example images captured by the camera 5d. The drawings illustrate simplified images captured by the camera 5d. Images RV10, RV11, RV12, and RV13 are captured from the same intersection at the same position. Images RV10 through RV13 contain a view at the intersection.

Image RV10 illustrated in FIG. 13 shows a rainless view. The image contains road sign RS, overpass OP as part of the view, and another vehicle VH and pedestrian PD as mobile objects.

Images RV11, RV12, and RV13 illustrated in FIGS. 14 through 16 show rainy views. In the drawings, raindrop LD is simplified as a circle. Raindrop LD irregularly refracts and reflects the light. Therefore, the range of raindrops LD prevents the frontal view from being recognized clearly.

Image RV11 illustrated in FIG. 14 contains the wiper 4b. In the image, the wiper 4b is viewed as a black zone divided by two parallel sides. The illustrated wiper 4b moves from the left to the right in image RV11. Inclusion of the wiper 4b in image RV11 can be determined by detecting a signal indicating the operation of the wiper 4b or recognizing a black area corresponding to the wiper 4b in image RV11.

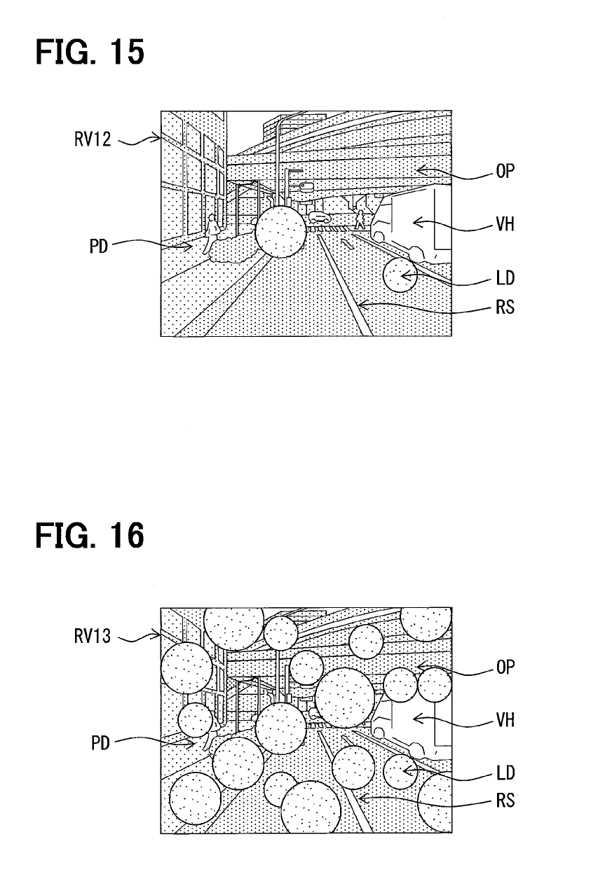

Image RF12 illustrated in FIG. 15 shows a view immediately after the wiper 4b passes. Image RF12 contains only a small number of raindrops LD. Image RF12 enables to clearly recognize the shapes such as road sign RS, overpass OP, another vehicle VH, and pedestrian PD.

Image RV13 illustrated in FIG. 16 shows a view after a long time elapses from the passage of the wiper 4b or a view immediately before the wiper 4b passes. Image RV13 contains many raindrops LD. Many raindrops LD hide things in the image. Image RF13 makes it difficult to clearly recognize the shapes such as road sign RS, overpass OP, another vehicle VH, and pedestrian PD. In particular, an image recognition program hardly identifies a specified shape from image RV13. It is difficult for the driver to accurately and fast recognize the captured things even if he or she views all or part of image RV13.

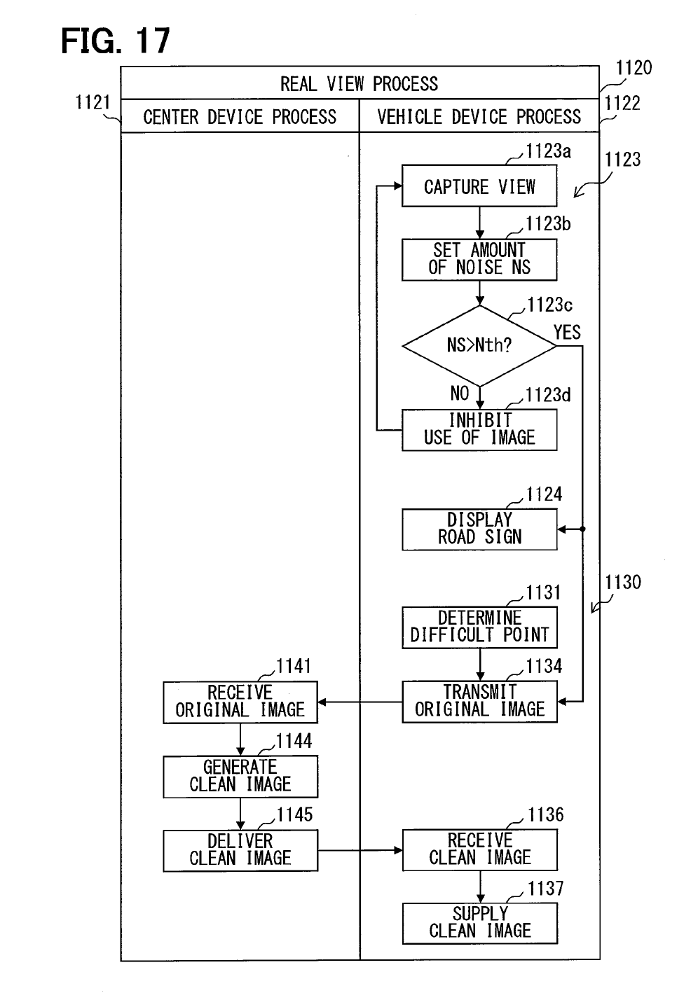

FIG. 17 is a flowchart illustrating a real view process 1120 related to the real view navigation provided by the vehicle navigation system 1. The real view navigation supplies a succeeding vehicle with an image captured by a preceding vehicle. The real view navigation delivers a clean image to the succeeding vehicle. The clean image is generated by removing mobile objects such as other vehicles and more preferably pedestrians from the image captured by the preceding vehicle. To generate a clean image, the real view navigation collects original images from several preceding vehicles. The real view navigation extracts a range of information useful for supporting the driving from an image representing a view ahead of the vehicle and displays the extracted range of information on the display device 5e in the vehicle.

The real view process 1120 contains a center device process 1121 performed by the center device 3 and a vehicle device process 1122 performed by the vehicle device 5. Each step can be assumed to be a processing means or portion that provides the corresponding function.

At step 1123, the vehicle device 5 captures an image representing a view ahead of the vehicle 4. Step 1123 can include a selection process that selects only an available image from several images captured by the camera 5d. For example, the selection process that can be included discards an image that captures the wiper 4b to remove raindrops stuck to the windshield 4a.

To perform step 1123, the vehicle device 5 sets the amount of noise elements contained in the image, namely, the amount of noise NS. Step 1123 can include a setup process to set the amount of noise NS contained in an image. The amount of noise NS can be set based on the degree or possibility of an image that may contribute to the driving support. The amount of noise NS may correspond to the ratio between the image and an area that does not correctly reflect the view. Noise elements captured in the image prevent a human being such as a driver from recognizing and understanding a thing captured in the image. Recognizing and understanding things becomes increasingly difficult as the amount of noise NS increases. The same applies to an image processing program that substitutes for the possibility of human recognition and automatically recognizes the presence of another vehicle, a pedestrian, or a road sign in the image.

Example noise elements include a raindrop or a snowflake stuck to the windshield. Example noise elements also include the wiper 4b itself. The wiper 4b itself may continue to be a noise element. A raindrop or a snowflake as a noise element may appear or disappear depending on states of the wiper 4b. A state of the wiper 4b indicates whether it is active (ON) or is inactive (OFF). Another state of the wiper 4b indicates whether or not it is captured in an image. Still another state of the wiper 4b indicates the time elapsed after the wiper 4b passes through capture range VR, namely, the time elapsed after the wiper 4b wipes capture range VR. The elapsed time is comparable to the number of raindrops or snowflakes contained in an image while the wiper 4b is operating.

Step 1123 can provide an inactivation setup portion that sets the amount of noise NS so as not to exceed specified threshold value Nth when the wiper 4b is inactive. Step 1123 can provide a wiper noise setup portion that sets the amount of noise NS so as to exceed specified threshold value Nth when an image contains the wiper 4b. Step 1123 can provide a proportion setup portion to increase the amount of noise NS as the amount of raindrops or snowflakes contained in an image increases. Step 1123 can provide an identification portion that identifies an image as being unusable and inhibits the use of the image when the amount of noise NS exceeds threshold value Nth indicating that an image can be appropriately used for the succeeding image utilization portion.

At step 1123a, the camera 5d captures a forward view. An image representing the view is input and is stored in the memory device 5b. This image signifies a raw image captured by the camera 5d of the vehicle 4. The image contains at least one still picture. The image may contain several still pictures or motion pictures.

Step 1123b provides an acquisition portion to acquire a state of the wiper 4b that wipes the outer surface of the windshield 4a. Step 1123b acquires first and second states of the wiper. The first state indicates that the amount of noise elements contained in the image does not exceed a specified threshold value. The second state indicates that the amount of noise elements contained in the image exceeds a specified threshold value. An example of the first state signifies that the wiper 4b is inactive. An example of the second state signifies that the wiper 4b is active. Another example of the first state signifies that the wiper 4b is not captured in an image. Another example of the second state signifies that the wiper 4b is captured in an image. Still another example of the first state signifies that an elapsed time after the wiper 4b passes through capture range VR does not exceed a specified time threshold value. Still another example of the second state signifies that an elapsed time after the wiper 4b passes through capture range VR exceeds a specified time threshold value.

At step 1123b, the vehicle device 5 evaluates the amount of noise NS contained in the image and sets the amount of noise NS for the image. The amount of noise NS is given based on the state of the wiper 4b. Step 1123b provides a setup portion that sets the amount NS of noise elements captured in the image.

According to this configuration, the wiper state is assumed to be the amount of noise elements. The identification portion identifies an image containing a small amount of noise elements as being usable and identifies an image containing a large amount of noise elements as being unusable.

At step 1123c, the vehicle device 5 determines whether or not the amount of noise NS exceeds specified threshold value Nth. If the amount of noise NS does not exceed threshold value Nth, the image is supplied to succeeding steps 1124 and 1130. If the amount of noise NS exceeds threshold value Nth, the vehicle device 5 proceeds to step 1123d. At step 1123d, the vehicle device 5 inhibits the use of the image.

Threshold value Nth identifies whether or not the image is usable for the driving support. Threshold value Nth also identifies whether or not the image is appropriate for the use at succeeding steps 1124 and 1130. Threshold value Nth can take different values corresponding to steps 1124 and 1130. For example, it is possible to provide first threshold value Nth1 indicating an image appropriate for first step 1124 and second threshold value Nth2 indicating an image appropriate for second step 1130. The use of an image is inhibited at first step 1124 if the amount of noise NS set for the image exceeds first threshold value Nth1. The use of an image is permitted at second step 1130 if the amount of noise NS set for the image does not exceed second threshold value Nth2.

Steps 1123c and 1123d provide an identification portion to identify, based on the state of the wiper 4b, whether or not the image is usable for the image utilization portion. Step 1123c identifies an image as being usable if the image is captured when the first state is acquired. Step 1123c identifies an image as being unusable if the image is captured when the second state is acquired. Step 1123c identifies an image as being usable if the image is captured when the amount of noise elements NS does not exceed specified threshold value Nth. Step 1123c identifies an image as being unusable if the image is captured when the amount of noise elements NS exceeds specified threshold value Nth.

Step 1124 performs a process that allows the display device 5e to display a road sign appearing ahead of the vehicle 4. The process recognizes the road sign from an image captured by the camera 5d. For example, the process recognizes a sign that indicates the destination at an intersection ahead. Further, the process extracts a partial image corresponding to the road sign and allows the display device 5e to display a magnified version of the extracted image. This enables to help the driver recognize the road sign.

At step 1130, the vehicle device 5 performs a clean image provision process that generates a clean image based on the image captured at the difficult point and supplies the clean image for driving support.

At step 1131, the vehicle device 5 determines whether or not the vehicle 4 travels the difficult point. The difficult point signifies a point on the road that makes it difficult for the driver to understand the road structure or the course. The difficult point may include a difficult intersection, namely, a branching point. The difficult point may include a branching point with many branches or a branching point with a special branch angle. Such an intersection is also referred to as a difficult intersection. The difficult point may include an entrance to the destination of the vehicle 4, a parking area entrance, or a similar point making it difficult to find while the vehicle travels. The difficult point may be determined automatically. Further, there may be provided a switch the driver manipulates when he or she finds a difficult point. The difficult point may be determined in response to manipulation of the switch.

The vehicle device 5 may determine that the vehicle 4 encounters a difficult point when detecting an abnormal event different from the normal state. For example, the vehicle device 5 may detect that the driver finds it difficult to select the travel direction at an intersection. In such a case, the vehicle device 5 can determine whether or not the intersection is a difficult intersection. The vehicle device 5 can use the behavior of the vehicle 4 or the driver to determine that the driver finds it difficult to select the travel direction. The behavior of the vehicle 4 may include the driver's manipulation on the vehicle 4, the state of the vehicle 4, and acceleration and deceleration of the vehicle 4.

The vehicle device 5 may determine a difficult point based on the driver's manipulation on the vehicle 4 or the behavior of the vehicle 4. An example of the vehicle behavior indicating a difficult point is sudden deceleration or sudden braking within a candidate range indicating candidate points such as intersections. Another example is slow driving in a candidate range. Still another example is stopped driving in a candidate range. Yet another example is meander driving in a candidate range. A difficult point may be determined based on a combination of several vehicle behaviors such as deceleration and meander driving.

To determine a difficult point, the vehicle device 5 compares the observed vehicle behavior with a predetermined reference behavior. If the observed vehicle behavior deviates from the reference behavior, the vehicle device 5 can determine the corresponding point as a difficult point. The reference behavior can be predetermined based on behaviors of many vehicles at the difficult point. The reference behavior may be also referred to as a standard behavior. The reference behavior can be adjusted to conform to a specific driver's personality. The reference behavior can be adjusted manually or according to a learning process to be described later.

The difficult point can be determined based on the driver's behavior. For example, the vehicle device 5 can determine whether or not the driver travels a difficult point based on the behavior such as the driver's body action, voice, or heartbeat. Specifically, the vehicle device 5 can use facial expressions, eye movement, or head movement. The vehicle device 5 can use the voice uttered by the driver when he or she takes a wrong route. More specifically, the vehicle device 5 can use uttered words such as “oops,” “damn,” “no,” and “what.” The vehicle device 5 can also use a sudden change in the heart rate.

To determine a difficult point, the vehicle device 5 compares the observed driver behavior with a predetermined reference behavior. If the observed driver behavior deviates from the reference behavior, the vehicle device 5 can determine the corresponding point as a difficult point. The reference behavior can be predetermined based on behaviors of many drivers at the difficult point. The reference behavior may be also referred to as a standard behavior. The reference behavior can be adjusted to conform to a specific driver's personality. The reference behavior can be adjusted manually or according to a learning process to be described later.

A difficult point may be determined based on a fact that the vehicle 4 deviates from a predetermined route scheduled for the route guidance. The vehicle 4 may deviate from the route at an intersection while the vehicle device 5 performs the route guidance. In such a case, the intersection is likely to be a difficult intersection.

Step 1131 provides a determination portion that determines a difficult point on a road that makes it difficult for the driver to understand the road structure or the course. The determination portion determines the difficult point based on comparison between the vehicle behavior and/or the driver behavior and the reference. Images for driving support can be automatically provided because the difficult point is determined automatically.

At step 1134, the vehicle device 5 transmits an image capturing the difficult point as an original image to the center device 3. The original image signifies a raw image captured by the camera 5d of the vehicle 4. The original image contains at least one still picture captured by the camera 5d immediately before the difficult point is reached. The difficult point is highly likely to be captured in such an image so that the corresponding road structure can be viewed. The original image may include several still pictures or motion pictures captured in a specified zone before the difficult point is reached or in a specified zone containing the difficult point. The original image can be selectively retrieved from still pictures or motion pictures captured in a specified travel distance or a specified travel period including the difficult point. Step 1134 provides a transmission portion that transmits the original image from the vehicle device 5 to the center device 3. One or more original images are transmitted. Step 1134 can transmit one or more images at one or more difficult points.

At step 1141, the center device 3 receives the original images transmitted from the vehicle devices 5. The center device 3 stores the received original images in the memory device 3b. Step 1141 provides an acquisition portion that acquires an original image captured at a specified point, namely, a difficult point.

At step 1144, the center device 3 generates a clean image based on the original image. At step 1144, the center device 3 generates a clean image at the difficult point. The clean image is void of mobile objects such as other vehicles and pedestrians captured. The clean image may be generated by selecting an original image with no mobile object captured from the stored original images per point. Alternatively, the clean image may be generated by removing mobile objects such as other vehicles and pedestrians captured from the original image.

To generate a clean image, an operator processes and corrects the original image. This manual process generates the clean image based on stored original images related to a targeted point. To generate a clean image, an image processing program can automatically generate one or more clean image based on the original images.

A process to generate a clean image includes several processes such as selecting a base image, identifying a mobile object in the base image, selecting another original image capable of supplying a background image to remove the mobile object, and synthesizing the other original image with the base image. The memory device 3b temporarily stores the images regardless of the manual process or the automatic process using the image processing program.

Selecting the base image is comparable to selecting one of original images that clearly indicates the difficult point. For example, the base image can be selected if it is an original image whose capture position is located within a specified range from the reference point of a difficult point such as a difficult intersection. Alternatively, the base image can be selected if it is an original image that satisfies a specified condition settled based on the width of a road connected to the difficult intersection. A mobile object in the base image can be identified based on a predetermined reference shape indicating a vehicle or a pedestrian.

Selecting another original image is comparable to selecting an original image similar to the base image. For example, another original image can be selected if it is an original image whose capture position is located within a specified range from the capture position of the base image. Alternatively, another original image can be selected if it is an original image that captures the position or shape of a remarkable object in the image such as a road sign similarly to the base image. Specifically, a stop line or a crosswalk may be used. It may be favorable to use an image process to recognize a range in the intersection.

A correction process based on a capture position or a date is performed to synthesize the base image with the other images (parts). The correction based on the capture position may include horizontal correction based on driving lane differences when the original image was captured. The correction based on the capture position may also include vertical correction based on height differences of the camera 5d. At least one mobile object is removed from the base image to generate a clean image. To do this, the other part of the original image is synthesized with the base image.

Step 1144 provides the generation portion that removes at least part of the mobile object such as the other vehicles and/or pedestrians from one original image to generate a clean image. The clean image is generated to support driving at a difficult point. The generation portion generates the clean image based on several original images. The generation portion synthesizes the original images based on capture conditions attached to the original images. To generate the clean image void of a mobile object, the generation portion synthesizes a range of one original image containing the captured mobile object with partial images in the other original images. Therefore, it is possible to provide an image approximate to the real scenery even if mobile objects are removed.

At step 1145, the center device 3 delivers the clean image to the vehicle device 5. Step 1145 included in the center device 3 provides a delivery portion that delivers a clean image to the vehicle device 5. The center device 3 can deliver the clean image to several vehicles 4. The center device 3 can deliver the clean image in response to a request from the vehicle 4. The center device 3 may deliver the clean image to the vehicle 4 that is going to reach one difficult point.

At step 1136, the vehicle device 5 receives the clean image. Step 1136 provides a vehicle reception portion that receives a clean image delivered from the delivery portion and stores the clean image in the memory device 5b.

At step 1137, the vehicle device 5 supplies the clean image to the driver. The display device 5e displays the clean image. The vehicle device 5 uses the clean image for route guidance. For example, the vehicle device 5 displays the clean image on the display device 5e before the vehicle 4 reaches a difficult point.

If the route guidance is performed, a guidance symbol can be displayed so as to overlap with the clean image. The guidance symbol may be provided as an arrow indicating a route or a multi-headed arrow indicating several branch directions selectable at a fork road. An image containing the clean image and the guidance symbol may be referred to as a guidance image. The vehicle device 5 can synthesize the guidance symbol with the clean image. The center device 3 may synthesize the guidance symbol with the clean image. The clean image and the guidance image are used for driving support.

Steps 1131, 1134, 1141, 1144, 1145, 1136, and 1137 provide a provision portion that provides an image to support driving at a difficult point based on the original image captured at the difficult point. According to the embodiment, at least steps 1144, 1145, 1136, and 1137 provide the provision portion. Step 1137 provides a display portion that allows the display device 5e to display a clean image stored in the memory device 5b when the vehicle travels a difficult point. Step 1130 including steps 1131 through 1137 and 1141 through 1145 provides an image delivery process that provides an image to support driving at a difficult point based on the original image captured at the difficult point. According to the embodiment, a sign display process provided at step 1124 or the image delivery process provided at step 1130 provides a utilization portion that uses an image captured at step 1123.

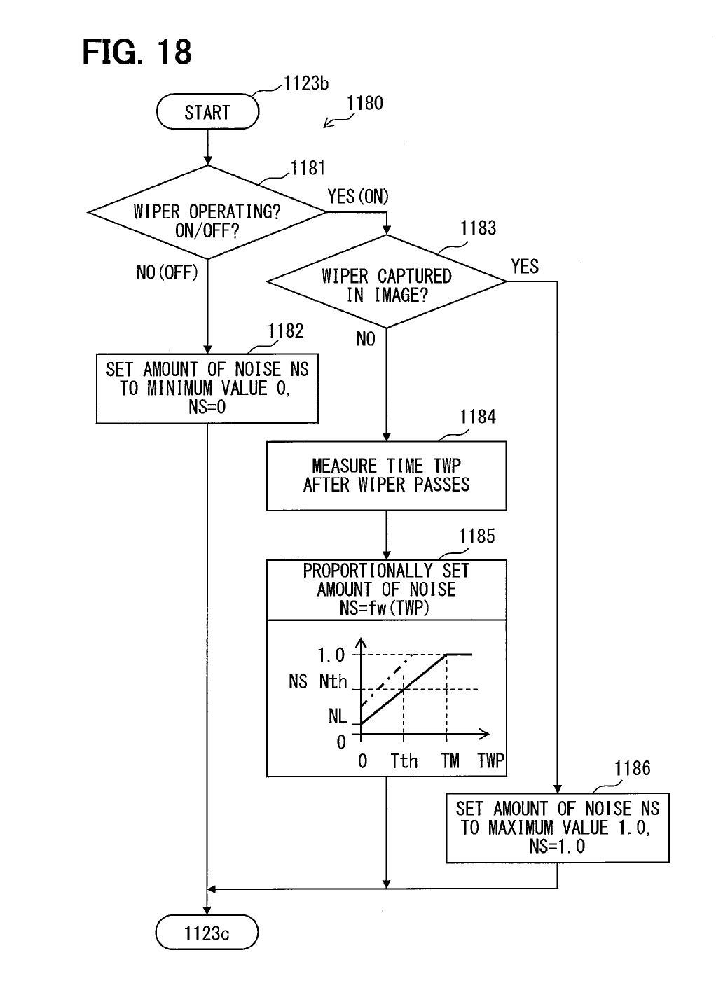

FIG. 18 illustrates a setup process 1180 that sets the amount of noise NS for one image based on the state of the wiper 4b. The setup process 1180 provides step 1123b. At step 1181, the process determines whether the wiper 4b is active (ON) or inactive (OFF). Turning the wiper 4b on or off can be determined based on the state of a wiper switch manipulated by the driver or a signal indicating the operation state of the wiper motor 4c. Turning the wiper 4b on or off may be determined based on whether or not the image contains a shadow corresponding to the wiper 4b at a specified cycle. The process proceeds to step 1182 if the wiper 4b is inactive. The process proceeds to step 1183 if the wiper 4b is active.

At step 1182, the process sets the amount of noise NS for the image to minimum value 0. This is because it is possible to assume no rain when the wiper 4b is inactive. Even if the wiper 4b is inactive, a sensor may be provided to detect that it rains. In such a case, the process may proceed to step 1183.

At step 1183, the process determines whether or not the image contains the wiper 4b. The process proceeds to step 1184 if the image does not capture the wiper 4b. The process proceeds to step 1186 if the image contains the wiper 4b.

At step 1184, the process measures elapsed time TWP after the wiper 4b passes through capture range VR of the camera 5d. A passage of the wiper 4b through capture range VR of the camera 5d can be determined based on disappearance of the shadow corresponding to the wiper 4b from the image or the operation position of the wiper 4b. Elapsed time TWP is available as a sawtooth wave whose cycle corresponds to the speed of the wiper 4b.

At step 1185, the process sets the amount of noise NS based on specified function fw(TWP) that uses elapsed time TWP as a variable. Function fw(TWP) sets the amount of noise NS in proportion to elapsed time TWP. As illustrated in FIG. 18, function fw(TWP) increases the amount of noise NS as elapsed time TWP increases.

Function fw(TWP) sets the amount of noise NS between minimum value 0 and maximum value 1.0. Function fw(TWP) sets the amount of noise NS to a value larger than predetermined value NL that is larger than minimum value 0. This step assumes a rainfall or a snowfall because the wiper 4b is active. In such a case, a water film or thin ice is likely to stick to the outer surface of the windshield 4a. Therefore, the amount of noise NS is set to be larger than predetermined value NL that is larger than minimum value 0.

Function fw(TWP) sets the amount of noise NS so as to exceed predetermined threshold value Nth if elapsed time TWP exceeds predetermined time threshold value Tth. This is because the amount of raindrops LD or snowflakes becomes too large if elapsed time TWP exceeds time threshold value Tth, causing the image unusable.

Function fw(TWP) sets the amount of noise NS to maximum value 1.0 if elapsed time TWP exceeds predetermined upper limit TM. This is because a large amount of raindrops LD causes the image too unclear to be used if elapsed time TWP exceeds upper limit TM.

Function fw(TWP) can include a characteristic that fast increases the amount of noise NS as the wiper 4b increases the speed. Function fw(TWP) can include characteristics that correspond to operation modes of the wiper 4b such as a high-speed mode and a low-speed mode. The driver increases the speed of the wiper 4b as the amount of rain increases. Therefore, increasing the speed of the wiper 4b increases the speed of increasing the amount of raindrop LD. When the wiper 4b operates in the low-speed mode, for example, function fw(TWP) is given the characteristic illustrated by a solid line. When the wiper 4b operates in the high-speed mode, function fw(TWP) is given the characteristic illustrated by a dash-and-dot line.

At step 1186, the process sets the amount of noise NS for the image to maximum value 1.0. This is because the image is assumed to be unusable when the image contains the wiper 4b.

To acquire the state of the wiper 4b, steps 1181 and 1182 provide an operation determination portion that determines whether or not the wiper 4b operates. The identification portion provided by step 1123c identifies an image as being usable if the image is captured when the wiper 4b is determined to be inactive. The image does not contain the wiper 4b when the wiper 4b is inactive. In addition, raindrop LD or a snowflake is unlikely to stick to the windshield 4a. Therefore, an image can be assumed to be usable if the image is captured when the wiper 4b is inactive.

To acquire the state of the wiper 4b, steps 1184 and 1185 provide a time determination portion that determines whether or not elapsed time TWP after passage of the wiper 4b through capture range VR exceeds predetermined time threshold value Tth. An identification portion provided by the time determination portion identifies an image as being usable if the image is captured when elapsed time TWP does not exceed time threshold value Tth. The identification portion identifies an image as being unusable if the image is captured when elapsed time TWP exceeds time threshold value Tth. This configuration identifies usable and unusable images according to the amount of raindrops or snowflakes that increases after the wiper 4b passes.

To acquire the state of the wiper 4b, steps 1183 and 1186 provide an image determination portion that determines whether or not the image contains the wiper 4b. The identification portion provided by the time determination portion identifies an image as being usable if the image contains the wiper 4b.

The embodiment provides a clear image when no rain or snow falls. In this case, the amount of noise NS for the image is set to minimum value 0 because the driver does not operate the wiper 4b. The amount of noise NS does not exceed threshold value Nth. Therefore, the image is identified as being usable and is supplied to steps 1124 and 1130 for use. Steps 1124 and 1130 provide an image utilization portion. Steps 1124 and 1130 provide a process to support driving based on the clear image.

When it rains or snows, the driver operates the wiper 4b. When the wiper 4b operates, it may be contained in the image. If the wiper 4b is contained in the image, the amount of noise NS for the image is set to maximum value 1.0. The image containing the wiper 4b is identified as being unusable and is not supplied to steps 1124 and 1130. This enables to avoid an uncertain process due to the wiper 4b.

The number of raindrops LD or snowflakes contained in the image cyclically varies like a sawtooth wave while the wiper 4b is operating. Therefore, a clear usable image can be acquired immediately after the wiper 4b passes through capture range VR of the camera 5d. However, raindrops LD or snowflakes cover much of capture range VR and an unusable image is acquired if the elapsed time exceeds a predetermined time threshold value after the wiper 4b passes through capture range VR of the camera 5d. Increasing elapsed time TWP after passage of the wiper 4b increases the amount of noise NS to correspond to the number of stuck raindrops LD or snowflakes.

If the amount of noise NS does not exceed threshold value Nth, the image is identified as being usable and is supplied to steps 1124 and 1130. Steps 1124 and 1130 provide a process to support driving based on a relatively clear image that does not exceed threshold value Nth.

If the amount of noise NS exceeds threshold value Nth, the image is identified as being unusable and is not supplied to steps 1124 and 1130. This enables to avoid an uncertain process due to raindrop LD or snowflake.

### Third Embodiment

This embodiment is a modification of the preceding embodiment as a basis. The above-mentioned embodiment permits the use of an image immediately after passage of the wiper 4b that is operating. Instead, the use of all images may be inhibited while the wiper 4b is operating.

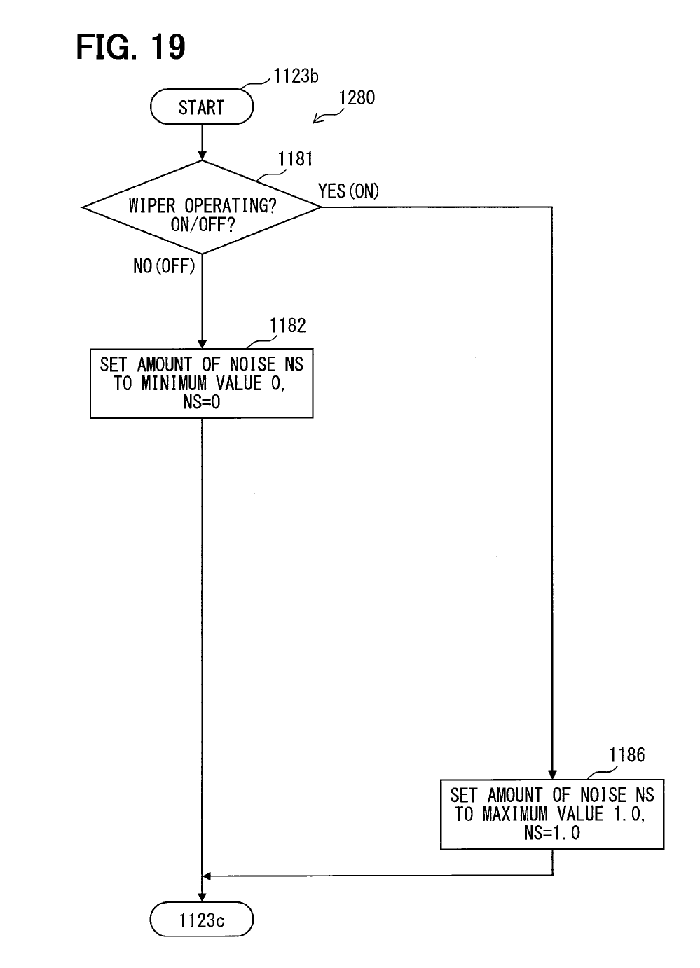

FIG. 19 illustrates a setup process 1280 according to the embodiment. In the embodiment, the process may determine at step 1181 that the wiper 4b is active. In this case the process proceeds to step 1186. While the wiper 4b is operating, an image may be degraded due to the wiper 4b, raindrop LD, or snowflake. A direct branch from step 1181 to step 1186 does not supply steps 1124 and 1130 with an image likely to be degraded. This enables to avoid the use of an image likely to be degraded.

The setup process 1280 provides an acquisition portion. To acquire the state of the wiper 4b, the acquisition portion includes an operation determination portion to determine whether or not the wiper 4b is active. The identification portion provided by the time determination portion identifies an image as being usable if the wiper 4b is determined to be inactive. The identification portion identifies an image as being unusable if the wiper 4b is determined to be active.

### Other Embodiments

While there have been described the preferred embodiments of the disclosures, the disclosures are not limited to the embodiments and may be variously modified. The structures of the above-mentioned embodiments are only examples. The technical scope of the disclosures is not limited to the scope of the description about the embodiments. The disclosures are not limited to the combinations described in the embodiments but may be embodied independently.

For example, the means and the functions provided by the control unit are available as software only, hardware only, or a combination of these. For example, the control unit may be configured as an analog circuit.

According to the above-mentioned embodiment, only the vehicle device 5 perform step 1124. Instead, the center device 2 may perform part of step 1124. For example, the center device 3 may collect sign images in the memory device 3b, select the most recent and high-quality sign image from the collected images, and deliver the selected sign image to the vehicle device 5 that displays the delivered sign image.

According to the above-mentioned embodiment, the center device 3 and the vehicle device 5 share several steps contained in step 1130. Instead, the center device 3 and the vehicle device 5 may share the steps differently from the above-mentioned embodiment. For example, the center device 3 may perform all or part of step 1131. The vehicle device 5 may perform all or part of steps 1141, 1144, and 1145.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

1. A vehicle navigation system comprising:
an acquisition portion that acquires an original image captured at a specified point; and
a generation portion that generates a clean image as an image for supporting driving at the specified point, the clean image being generated by removing at least a part of a mobile object, which includes another vehicle or a pedestrian, from the original image,
wherein the acquisition portion includes a storage portion to store a plurality of original images,
wherein the generation portion generates the clean image based on the plurality of original images,
the vehicle navigation system further comprising:
a confirmation portion that permits the generation portion to generate the clean image when a point to have captured the original image is confirmed to be valid for generating the clean image,
wherein the confirmation portion confirms validity of a point to generate the clean image when the number of stored original images exceeds a predetermined threshold value.

2-4. (canceled)

5. The vehicle navigation system according to claim 1,
wherein the generation portion generates the clean image, from which the mobile object is removed, by synthesizing a range of capturing the mobile object in one of the original images with a partial image in another one of the original images.

6. The vehicle navigation system according to claim 5,
wherein the acquisition portion acquires information indicating a capture condition about each of the original images, and
wherein the generation portion synthesizes the plurality of original images based on the capture condition.

7. The vehicle navigation system according to claim 1, further comprising:
a plurality of vehicle devices, each of which is mounted on a vehicle; and
a center device communicably connected to the plurality of vehicle devices,
wherein each of the vehicle devices includes:
a camera that captures a view ahead of the vehicle to supply the original image; and
a transmission portion that transmits the original image from the vehicle device to the center device,
wherein the center device includes:
the acquisition portion to acquire the original image;
the generation portion to generate the clean image; and
a delivery portion that delivers the clean image to the vehicle devices,
wherein the acquisition portion includes a center reception portion to receive the original image transmitted from the transmission portion, and
wherein each of the vehicle devices further includes:
a vehicle reception portion that receives the clean image delivered from the delivery portion and stores the clean image in a storage device; and
a display portion that controls a display device to display the clean image stored in the storage device when the vehicle travels through the specified point.

8. An image capture device for a vehicle to provide an image, captured through a windshield of the vehicle, to an image utilization portion, the image capture device comprising:
an acquisition portion that acquires a state of a wiper that wipes an outer surface of the windshield; and
an identification portion that determines, based on the state of the wiper, whether the image is usable for the image utilization portion,
wherein, to acquire the wiper state, the acquisition portion includes a time determination portion that determines whether an elapsed time after the wiper passes through a capture range exceeds a predetermined time threshold value,
wherein the identification portion identifies the image as the usable image when the image is captured, and the elapse time does not exceed the time threshold value, and
wherein the identification portion identifies the image as the unusable image when the image is captured, and the elapse time exceeds the time threshold value.

9. The image capture device for vehicle according to claim 8,
wherein the acquisition portion acquires:
a first state of the wiper indicating that an amount of noise element disposed in the image does not exceed a predetermined threshold value; and
a second state indicating that the amount of noise element disposed in the image exceeds the threshold value,
wherein the identification portion identifies the image as a usable image when the image is captured, and the first state is acquired, and
wherein the identification portion identifies the image as a unusable image when the image is captured, and the second state is acquired.

10. The image capture device for vehicle according to claim 8,
wherein, to acquire the wiper state, the acquisition portion includes an operation determination portion that determines whether the wiper is active or inactive, and
wherein the identification portion identifies the image as the usable image when the image is captured, and the wiper is determined to be inactive.

11. (canceled)

12. The image capture device for vehicle according to claim 8,
wherein, to acquire the wiper state, the acquisition portion includes an image determination portion that determines whether the wiper is captured in the image, and
wherein the identification portion identifies the image as the unusable image when the wiper is captured in the image.

13. (canceled)

14. The image capture device for vehicle according to claim 8,
wherein the acquisition portion provides a setup portion that sets an amount of noise captured in the image based on the wiper state,
wherein the identification portion identifies the image as the usable image when the image is captured, and the amount of noise does not exceed a predetermined threshold value, and
wherein the identification portion identifies the image as the unusable image when the image is captured, and the amount of noise exceeds the predetermined threshold value.

15. A vehicle navigation system comprising:
an acquisition portion that acquires an original image captured at a specified point; and
a generation portion that generates a clean image as an image for supporting driving at the specified point, the clean image being generated by removing at least a part of a mobile object, which includes another vehicle or a pedestrian, from the original image,
wherein the acquisition portion includes a storage portion to store a plurality of original images,
wherein the generation portion generates the clean image based on the plurality of original images,
wherein the generation portion generates the clean image, from which the mobile object is removed, by synthesizing a range of capturing the mobile object in one of the original images with a partial image in another one of the original images,
wherein the acquisition portion acquires information indicating a capture condition about each of the original images, and
wherein the generation portion synthesizes the plurality of original images based on the capture condition.

16. The vehicle navigation system according to claim 15, further comprising:
a confirmation portion that permits the generation portion to generate the clean image when a point to have captured the original image is confirmed to be valid for generating the clean image.

17. The vehicle navigation system according to claim 15, further comprising:
a plurality of vehicle devices, each of which is mounted on a vehicle; and
a center device communicably connected to the plurality of vehicle devices,
wherein each of the vehicle devices includes:
a camera that captures a view ahead of the vehicle to supply the original image; and
a transmission portion that transmits the original image from the vehicle device to the center device,
wherein the center device includes:
the acquisition portion to acquire the original image;
the generation portion to generate the clean image; and
a delivery portion that delivers the clean image to the vehicle devices,
wherein the acquisition portion includes a center reception portion to receive the original image transmitted from the transmission portion, and
wherein each of the vehicle devices further includes:
a vehicle reception portion that receives the clean image delivered from the delivery portion and stores the clean image in a storage device; and
a display portion that controls a display device to display the clean image stored in the storage device when the vehicle travels through the specified point.
